(19) United States
(12) Patent Application Publication
(10) Pub. No.: US 2026/0024452 A1
(43) Pub. Date: Jan. 22, 2026

(54) GENERATING VIDEO RESPONSE AND EDUCATION MATCHING GAME CONTENT USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventors: Niraj Patel, London (GB); Janet Demir, Ortaca (TR); Sean Carlson, Austin, TX (US); Akshay Mate, Nanaimo (CA); Hossam Arafat, Austin, TX (US)

(73) Assignee: 2hr Learning, Inc., Austin, TX (US)

(21) Appl. No.: 19/273,080

(22) Filed: Jul. 17, 2025

Related U.S. Application Data
(60) Provisional application No. 63/672,420, filed on Jul. 17, 2024.

(51) Int. Cl. G09B 5/06

(52) U.S. Cl. CPC G09B 5/06

(57) ABSTRACT

The content generation system and content generation process utilizes a prompt to guide an Artificial Intelligence (AI) engine for dynamically generating educational content, for creating an educational matching game content. The method and system utilizes an educational curriculum database to receive input, including educational standards and course details. The input is used to retrieve information for a historical figure relevant to the educational standard from the curriculum database, which includes the historical figure's image and voice. Additionally, a AI engine generates facts for the educational standard associated with the educational matching game content to ensure the educational content is rich and comprehensive. The system generates video response to present the educational content using the historical figure, adding an engaging multimedia element to the learning experience. A prompt is generated to guide and constrain the AI engine in analyzing the educational content and generating key-value pairs.

### CROSS-REFERENCE TO RELATED APPLICATION(S)

This application claims the benefit under 35 U.S.C. § 119 (c) and 37 C.F.R. § 1.78 of U.S. Provisional Application No. 63/672,420, which is incorporated by reference in its entirety.

### FIELD OF THE INVENTION

The present invention relates in general to the field of electronics, and more specifically to a content generation system and content generation method to utilize educational content for dynamically generating an educational matching game content.

### BACKGROUND

Educational content encompasses a wide range of materials, resources, and media designed to facilitate learning and knowledge acquisition. The educational content can include textbooks, worksheets, digital platforms, quizzes, interactive modules, and various other resources specifically created to support educational objectives of the students. The need for educational content arises from the diverse learning requirements of students and the dynamic nature of educational standards. Highly tailored and adaptive educational content is essential to address individual learning styles, cater to diverse academic standards, and support customized learning experiences. The educational content enables personalized learning experiences by catering to the individual pace, style, and preferences of learners. This adaptability ensures that students receive content tailored to their needs, thus enhancing their comprehension and retention. Additionally, educational content that is interactive and engaging can contribute significantly to student motivation and participation. Interactive elements, such as quizzes, simulations, and multimedia resources, facilitate active learning and make the educational process more enjoyable and effective. Furthermore, high-quality educational content aligns with specific educational standards and objectives, helping the students to prepare thoroughly for assessments and ensuring that learning materials are comprehensive and relevant.

However, traditional educational tools often rely on static content that does not adapt to the varying educational standards or the specific needs of different courses. This static nature means that the educational content may not always be relevant or engaging for all students, leading to a lack of personalized learning experiences. Moreover, the traditional educational tools do not offer interactive elements that engage students actively. The static textbooks or worksheets provide information but do not adapt to student responses or allow for dynamic interaction based on student performance. Furthermore, updating traditional educational materials to reflect new standards or educational insights is often a slow and resource-intensive process. The schools and educators frequently have to wait for new editions of textbooks or revised materials to incorporate updated content.

The traditional educational tools often provide generic content that is not tailored to the specific nuances of a course's standards or objectives. This can lead to gaps in learning where the students are not adequately prepared for assessments that are closely aligned with specific educational standards. Additionally, the traditional educational tools involved manual curation and assembly by educators or publishers. Typically, the subject matter experts compile and review content to create textbooks that align with educational standards. However, these are fixed once published and cannot adapt dynamically. Moreover, the educators design worksheets and educational materials manually, which can be time-consuming and may not perfectly align with every standard or student need. In recent times, some digital platforms provide quizzes and learning modules, but the digital platforms often lack customization to specific standards or the ability to dynamically generate new content based on real-time educational requirements.

### SUMMARY

In at least one embodiment, a method integrates programmatic control and a guided and constrained Artificial Intelligence (AI) engine to utilize educational content for dynamically generating educational matching game content. The method includes executing code using one or more processors of a computer system to cause the computer system to perform operations. The operations include utilizing an educational curriculum database for receiving input, where the input includes educational standards and course details. The operations include retrieving information for a historical figure relevant to the educational standard from the educational curriculum database, where the relevant information for the historical figure includes a historical figure image and voice. The operations include utilizing the AI engine to generate facts for the educational standard associated with the educational matching game content. The operations include generating a video response using a video generation module to present the educational content using the historical figure. The operations include generating a prompt to guide the AI engine to analyze educational content and generate key-value pairs. The operations include transferring the prompt to the AI engine to generate key-value pairs, where the key represents a significant educational concept or event, and the value provides a detailed explanation or outcome related to the key. The operations include displaying the generated educational matching game content and the generated video response.

In at least one embodiment, a system integrates programmatic control and a guided and constrained Artificial Intelligence (AI) engine to utilize educational content for dynamically generating educational matching game content. The system includes one or more processors of a computer system and a memory, coupled to the one or more processors, storing code that, when executed, causes the computer system to perform operations. The operations include utilizing an educational curriculum database for receiving input, where the input includes educational standards and course details. The operations include retrieving information for a historical figure relevant to the educational standard from the educational curriculum database, where the relevant information for the historical figure includes a historical figure image and voice. The operations include utilizing the AI engine to generate facts for the educational standard associated with the educational matching game content. The operations include generating a video response using a video generation module to present the educational content using the historical figure. The operations include generating a prompt to guide the AI engine to analyze educational content and generate key-value pairs. The operations include transferring the prompt to the AI engine to generate key-value pairs, where the key represents a significant educational concept or event, and the value provides a detailed explanation or outcome related to the key. The operations include displaying the generated educational matching game content and the generated video response.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary content generation system to utilize educational content for dynamically generating educational matching game content.

FIG. 2 depicts an exemplary content generation process utilized by the content generation system.

FIG. 3 depicts an educational matching game content generation process, which is an embodiment of the content generation process of FIG. 2

FIG. 4 depicts a relationship between educational standard, domain, and cluster.

FIG. 5 depicts an exemplary user interaction process, which is an embodiment of the content generation process of FIG. 2.

FIG. 6 depicts another exemplary user interaction process, which is an embodiment of the content generation process of FIG. 2

FIGS. 7-10 are exemplary user interfaces depicting interaction between the user and the online learning platform.

FIG. 11 depicts an exemplary network environment in which the system of FIG. 1 and the process of FIG. 2 may be practiced.

FIG. 12 depicts an exemplary computer system.

### DETAILED DESCRIPTION

The content generation system and content generation process utilizes a prompt to guide an Artificial Intelligence (AI) engine to utilize educational content, for dynamically creating an educational matching game content. The method and system utilizes an educational curriculum database to receive input, including educational standards and course details. The input is used to retrieve information for a historical figure relevant to the educational standard from the curriculum database, which includes the historical figure's image and voice. Additionally, a Large Language Model (LLM) is utilized to generate facts for the educational standard associated with the educational matching game content to ensure the educational content is rich and comprehensive. Furthermore, generating a video response using a video generation module to present the educational content using the historical figure, adding an engaging multimedia element to the learning experience.

Subsequently, a prompt is generated to guide the AI engine in analyzing the educational content and generating key-value pairs. The key-value pairs represent educational concepts or events and provide detailed explanations or outcomes related to the key. Furthermore, displaying the generated educational matching game content and the generated video response on a user interface. Additionally, the system is configured to automatically update and generate educational content based on received updates related to changes in educational standards to ensure that the content remains relevant and up-to-date, meeting the evolving needs of educational environments. The educational matching game content is designed to cover various types, including cause to effect, term to explanation, people to event, and event to date. The generation of key-value pairs is supported by a rules-based engine configured to ensure alignment with specific educational standards, enhancing the contextually relevant generation of educational matching game content to ensure that the content is closely aligned with established educational guidelines and requirements.

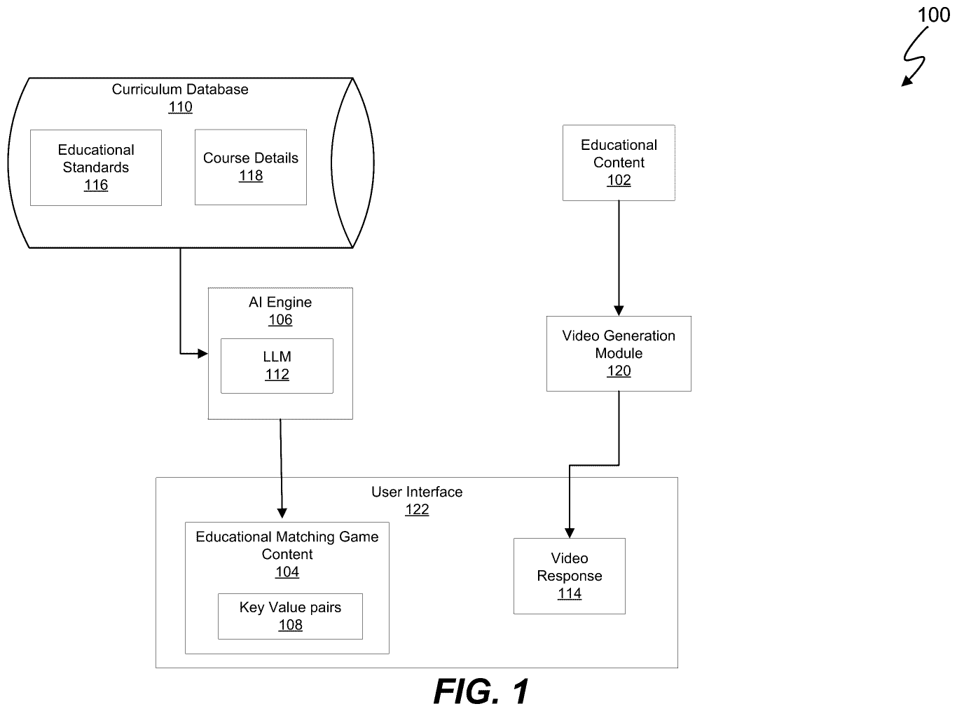

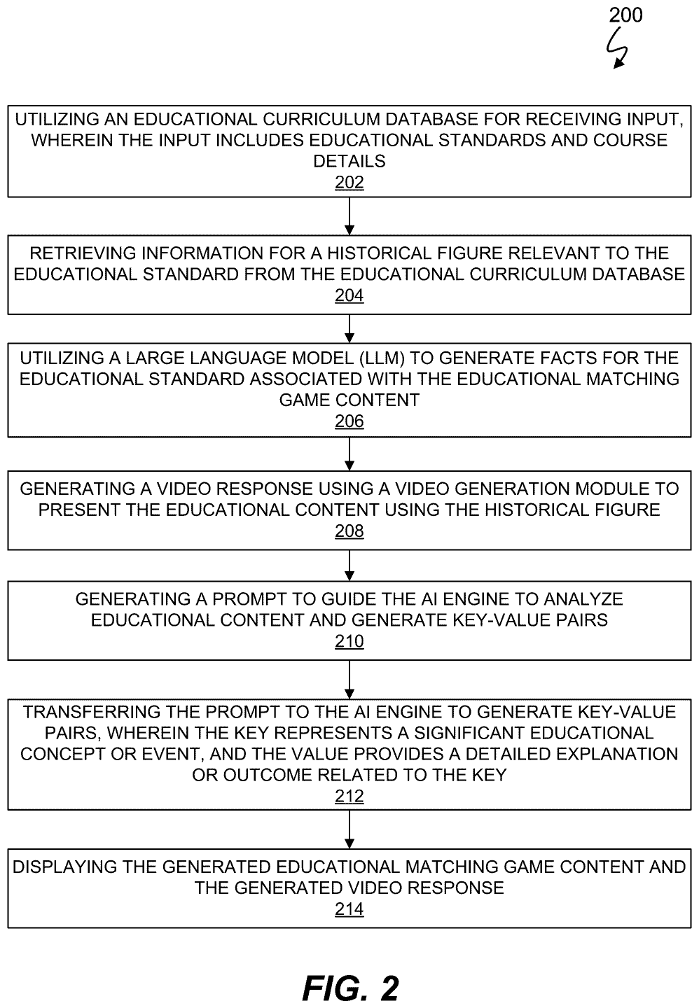

FIG. 1 depicts an exemplary content generation system 100 to utilize educational content 102 for dynamically generating educational matching game content 104. FIG. 2 depicts an exemplary content generation process 200 utilized by the content generation system 100.

The Artificial Intelligence (AI) engine 106 is designed to analyze the educational content 102 and generate key-value pairs 108 for the user. The AI engine 106 seamlessly integrates with an extensive educational curriculum database 110 for receiving input. The AI engine 106 utilizes a Large Language Model (LLM) 112 to generate facts for the educational standard. Moreover, the content generation system 100 generates a video response 114 to present the educational content 102 using the historical figure. Based on a prompt the AI engine 106 analyzes educational content 102 and generates key-value pairs 108. Typically, displaying the generated educational matching game content 104 and the generated video response 114.

Referring FIG. 1 and FIG. 2, in operation 202, utilizing the educational curriculum database 110 for receiving input. The input includes educational standards 116 and course details 118. The educational curriculum database 110 is a structured repository that stores various elements related to curriculum planning and delivery. The educational curriculum database 110 includes educational standards 116, course details 118, learning objectives, assessment methods, instructional materials, and so forth. The educational curriculum database 110 enables educators, administrators, and policymakers to access, update, and utilize the data efficiently, thus fostering coherent and aligned educational experience.

The educational standards 116 are guidelines that define what users should know and be able to do at each grade level. The users include students, educators, researchers, and learners seeking to expand their knowledge and understanding of various subjects. The educational standards 116 provide a framework for development of the curriculum, ensuring consistency and quality across different educational settings. When the educational standards 116 are input into the curriculum database 110, the educational standards 116 serve as a reference point for developing and aligning courses and instructional materials to ensure that the curriculum meets the required educational benchmarks and prepares the user for future academic and career success.

The course details 118 encompass a wide range of information, including course titles, descriptions, learning objectives, prerequisites, instructional materials, and assessment methods. Inputting the course details 118 into the curriculum database 110 allows for comprehensive course planning and organization. Additionally, the curriculum database 110 supports course scheduling, resource allocation, and streamlining administrative processes and enhancing the overall efficiency. The utilizing the curriculum database 110 ensures alignment between educational standards 116 and course detail 118. Moreover, the curriculum database 110 stores detailed information about course details 118 specific to each grade the user is supposed to learn, the curriculum database 110 enables tailor instruction to meet the diverse needs of the user. By analyzing the data stored in the curriculum database 110 enables identifying trends, assessing the effectiveness of instructional strategies, and making informed decisions about curriculum development and resource allocation.

Moreover, automatically updating and generating educational content 102 in response to changes in educational standards 116 to ensure that the educational content 102 remains relevant, accurate, and aligned with the latest curricular requirements. Typically, the educational standards 116 are set by educational authorities or institutions and are designed to ensure consistency and quality in education across different schools and regions. However, the educational standards 116 are not static and are periodically reviewed and updated to reflect new research findings, societal needs, and technological advancements. As the educational standards 116 evolve, educational content 102 must also be updated to ensure that the educational content 102 aligns with the latest expectations. The educational standards 116 are continuously monitored to identify any change. Once changes are detected, the impact of the changes are analyzed on existing educational content 102. After identifying the areas that need updating, the educational content 102 is updated to align with the updated educational standards 116.

Moreover, receiving input that represents educational standards 116 and course details 118, and subsequently categorizing the received data into a structured format. The course details 118 include curricular components such as course objectives, topics, learning outcomes, instructional materials, and assessment methods. Once the information is received, it undergoes a transformation into a structured format to facilitate effective data management and utilization. Structuring the data involves categorizing the educational standards 116 and course details 118 into logical groups based on themes, subjects, grade levels, or competencies. The categorization allows aligning the curriculum with specified standards. The structured data enhances accessibility and flexibility, allowing for easy updating, sharing.

In operation 204, retrieving information for a historical figure relevant to the educational standard 116 from the educational curriculum database 110. The relevant information for the historical figure includes historical figure image, voice designed to align with educational standard 116 and learning objective of the user. The educational curriculum database 110 can store diverse types of data associated with the historical figure such as textual descriptions, visual media, and audio simulations to present a multi-faceted and engaging view of history to the user. The historical figures are included to provide concrete examples of key events, movements, and concepts that the user is expected to learn. The educational standards 116 specify that the user should understand the impact of figures like Martin Luther King Jr., Albert Einstein, or James Madison on their respective fields and historical periods. Therefore, the curriculum database 110 stores information that meets the educational requirements.

The curriculum database 110 can access a curated set of data that has been selected and organized to align with the educational standards 116. The set of data includes a detailed biography of the historical figure, outlining the life, achievements, and influence of the historical figure on history. The images of historical figures help the user in visualizing and connecting with the past. The curriculum database 110 also stores high-quality images that depict the historical figures in historical context, helping to bring history to life. The visual representations help in engaging the user and aiding in understanding the historical events. The voice simulations or audio recordings provide the user with an auditory experience that complements the visual information. Hearing the voices of the historical figures can create a sense of immediacy and presence, allowing the user to engage with history in an immersive way. The voice includes authentic recordings of speeches or digitally recreated voices of the historical figures. The curriculum database 110 allows to filter and sort information to quickly find the most relevant content. For example, younger users might benefit from simplified biographies and colorful illustrations, while older users might engage more with primary source documents and critical analyses.

In operation 206, utilizing the LLM 112 to generate facts for the educational standard 116 associated with the educational matching game content 104. The LLM 112 are trained on diverse datasets containing billions of words and phrases, enabling the LLM 112 to recognize patterns, context, and nuances to generate facts for the educational standard 116 associated with the educational matching game content 104. The educational standards 116 serve as benchmarks for what the user should know and be able to do at various stages of their academic journey. Using the LLM 112 to generate facts for the educational content 102 involves designing prompts that guide the LLM 112 to produce information relevant to the educational standards 116. For example, to teach the user about historical events, the LLM 112 generates factual statements, trivia, or context about those events that align with the curriculum.

The LLM 112 creates dynamic content that can adapt to the needs and interests of the user. For example, in the educational matching game content 104 designed to teach biology, the LLM 112 generates facts about different species, habitats, and biological processes. The LLM 112 creates multiple variations of questions, hints, and explanations, ensuring that the users are exposed to diverse aspects of the subject matter. Moreover, the LLM 112 generates content tailored to different learning levels and styles. By adjusting the complexity and depth of the information provided. The educational matching game content 104 offers real-time feedback and explanations to the user, fostering a more interactive learning environment. For example, when the user selects an incorrect answer, the educational matching game content 104 provides a tailored explanation generated by the LLM 112, helping the user to understand the correct answer and learn from their mistake. Furthermore, the ability of LLM 112 to generate dialogue enhances the sense of immersion in the educational matching game content 104. The integration of LLM 112 allows creation of more engaging, personalized, and effective learning experiences for the user.

The LLM 112 ensures the content generated aligns with pedagogical goals and standards of the user. The LLM 112 creates adaptive learning environments that adjust content in real-time based on the user performance and engagement. By analyzing data on the user interactions, the LLM 112 tailors content to address individual learning gaps and challenges, providing a truly personalized learning experience.

In operation 206, generating the video response 114 using a video generation module 120 to present the educational content 102 using the historical figure. The video response 114 conveys information in an engaging and accessible manner. The video response 114 combines visual and auditory elements, making complex concepts easier to understand and remember. The video response 114 breaks down complex subjects into easy segments, helping the user to better absorb and retain information. Additionally, the video response 114 allows for the inclusion of animations, graphics, and other visual aids that can illustrate difficult concepts effectively.

The video generation module 120 is a tool that can create video response 114. The video generation module 120 generates the video response 114 featuring historical figures, providing an engaging way to present learning materials. The video generation module 120 works by combining data, such as images and text, such as voice overs or animations, to create the video response 114. When generating the video response 114 using the historical figure, the video generation module 120 gathers relevant data about the historical figure, such as biographical information, key achievements, and historical context. Moreover, audio elements, such as voice overs or background music, are added to the video to create a more immersive experience.

The video response 114 captures the user's attention by combining visuals, audio, and narrative elements. The video response 114 can be paused, replayed, and reviewed at the user's own pace, allowing for a personalized learning experience. The video generation module 120 creates educational content 102 tailored to individual user learning needs and preferences. By adjusting the complexity and depth of the information presented, to ensure that the video response 114 aligns with the user current level of understanding.

In operation 208, generating a prompt to guide the AI engine 106 to analyze educational content 102 and generate the key-value pairs 108. The key-value pairs 108 are data structures where each piece of data is stored as a key (a unique identifier) and its corresponding value (the data associated with that key). By generating key-value pairs 108, the educational content 102 can be efficiently organized, searched, and analyzed, enhancing the educational experience. The key-value pairs 108 are foundational to data organization and retrieval. Each key is paired with a value, allowing for easy mapping and retrieval of data. For example, a key might be a concept such as “photosynthesis,” and the value could be a detailed explanation or a list of its stages.

The AI engine 106 analyzes the educational content 102 and extract key-value pairs 108 to understand, interpret, and generate human language, allowing to process educational content 102 in natural language and extract meaningful information. The AI engine 106 analyzes educational texts, identifies key concepts, and determines the relationships between the concepts and their corresponding explanations to generate key-value pairs 108 that accurately represent the educational content 102 and meaning. To guide the AI engine 106 in analyzing educational content 102 and generating the key-value pairs 108, the prompts are utilized. The Prompts are inputs that direct the AI engine 106 to process and generate the key-value pairs 108. Moreover, the prompt should clearly state the objectives, specifying the type of content to be analyzed and the desired output format. For example, the prompt instructs the AI engine 106 to “Analyze the provided educational text and generate key-value pairs 108 where keys are scientific concepts, and values are their definitions.”

Typically, the AI engine 106 begins by parsing the educational content 102, breaking the educational content 102 down into smaller, manageable segments such as sentences or paragraphs to focus on individual components of the text and identify key elements. The AI engine 106 identifies key concepts within the content, recognizing terms and phrases that represent important ideas or topics. This step often involves recognizing subject-specific terminology and understanding the context in which concepts are presented. Moreover, the AI engine 106 analyzes the context surrounding each concept, determining the relationship between the concept (key) and its corresponding explanation (value). The AI engine 106 generates key-value pairs 108 by pairing identified concepts with their corresponding explanations. The AI engine 106 presents the generated key-value pairs 108 in a format suitable for integration into educational systems. The generation of key-value pairs 108 from educational content 102 allows for personalized learning experiences by tailoring content to individual user needs and preferences.

In operation 210, transferring the prompt to the AI engine 106 to generate key-value pairs 108. The key represents a significant educational concept or event, and the value provides a detailed explanation or outcome related to the key. The key-value pair 108 categorizes and clarifies information for easy retrieval. A “key” serves as a unique identifier for the educational concept 102 or event, while the “value” is the corresponding explanation, definition, or outcome associated with that key. For example, in history, a key could be “Industrial Revolution,” and the value can be “a period of major industrialization from the late 18th to early 19th century that transformed largely agrarian, rural societies in Europe and America into industrialized, urban ones.”

The prompt guides the AI engine 106 to generate accurate and relevant key-value pairs 108. The prompt acts as an instruction set that instructs the AI engine 106 what to focus on and how to process the received information. The prompt must be clear and specific to enhance the quality of the output, ensuring that the key-value pairs 108 generated are aligned with educational objectives associated with the user. In at least one embodiment, providing examples within the prompt to guide the AI engine 106. “For example, key: ‘World War II’, value: ‘A global conflict from 1939 to 1945 involving most of the world's nations, resulting in significant geopolitical changes.’” Once the prompt is generated, the prompt is transferred to the AI engine 106 to initiate the process of generating key-value pairs 108.

Moreover, generating the key-value pairs 108 using a rules-based engine to create contextually relevant educational matching game content 104 to ensure alignment with the educational standards 116. The rules-based engine uses predefined rules to process data to make decisions. The rules-based engine is configured to ensure that the content aligns with established educational standards 116 and learning objectives. For example, in a history curriculum, a key might be a historical figure, and the value could be a brief description of their achievements or impact. The educational standards 116 outline the knowledge and skills that the user is expected to acquire and provide the framework for the predefined rules that will guide content generation. Based on the educational standards, specific rules are developed to guide the generation of key-value pairs 108. The predefined rules specify the criteria that the content must meet, such as including specific vocabulary, addressing particular topics, or emphasizing certain learning objectives.

To ensure that the generated content is contextually relevant, the rules-based engine is configured to consider the context in which the content will be used. Once the rules are established, the rules-based engine can automatically generate key-value pairs that meet the specified criteria. The key-value pairs 108 generated by the rules-based engine are used to create educational matching game content 104.

In at least one embodiment, the AI engine 106 leverages NLP to understand the structure and meaning of the content. The NLP identifies key concepts or events by recognizing specific terms, patterns, or themes within the text. The AI engine 106 then extracts the relevant details associated with each key, ensuring that the values are comprehensive and informative. Typically, the content is broken down into manageable segments, such as sentences or paragraphs, allowing the AI engine 106 to focus on specific sections. The AI engine 106 identifies significant educational concepts 102 within the text by recognizing keywords, themes, or topics. The AI engine 106 analyzes the context surrounding each concept, determining the relationship between the key and its corresponding value. The AI engine 106 extracts relevant information that forms the value for each key, ensuring that the explanations are detailed and aligned with educational standards 116. Then the AI engine 106 generates the key-value pairs 108, presenting in a structured format.

In operation 212, displaying the generated educational matching game content 104 and the generated video response 114. The educational matching game content 104 is interactive matching game designed to reinforce learning by requiring the users to match related items, such as terms with definitions, images with concepts, or questions with answers. The educational matching game content 104 is effective because, the educational matching game content 104 promotes active learning, improves memory retention, and makes the learning process enjoyable. The educational matching game content 104 is generated based on learning objectives or curriculum standards. The educational matching game content 104 involves creating pairs of related items that challenge the user to identify connections and reinforce understanding of the material. For example, in a biology class, the educational matching game content 104 involves pairing anatomical terms with their corresponding functions or descriptions.

The generated educational matching game content 104 and the generated video response 114 is displayed on a user interface 122. Typically, the user interface 122 is intuitive and visually appealing, guiding the user through the educational matching game content 104 effortlessly. Moreover, the educational matching game content 104 should be accessible across various devices, including desktops, tablets, and smartphones. Furthermore, the user interface 122 provides immediate feedback in the educational matching game content 104. As the user makes selections, the user interface 122 should offer real-time feedback, such as confirming correct matches or highlighting incorrect ones. In at least one embodiment, the user interface. Display the user progress throughout the educational matching game content 104, such as the number of matches completed or time taken.

Additionally, the generated video responses 114 are dynamic, multimedia presentations that convey educational content 102 through visual and auditory elements. Effectively displaying generated video responses requires careful consideration of the user experience and technological infrastructure. The user can access the video response 114 seamlessly on the user interface 122. Moreover, integrating educational matching game content 104 and video response 114 within the user interface 122 to provide a comprehensive approach of learning. For example, the user watches the video response 114 to gain foundational knowledge and then apply that knowledge in the educational matching game content 104. Integrating the educational matching game content 104 and video response 114 can be used for personalized learning allowing the user to progress at their own pace and access content that aligns with their interests and goals.

The educational matching game content 104 is generated from cause to effect type, term to explanation type, people to event type, event to date type. The cause to effect type involves creating matching pairs where users match a cause with its corresponding effect. The term to explanation type allows the user to match a specific term with its correct definition or explanation. The people to event type involves matching historical figures with the events they are associated with. The event to date type involves matching events with the dates on which they occurred, helping the user to memorize and contextualize historical timelines.

Below is an exemplary prompt for cause to effect type for subject AP US history.

### Context

You are an educational matching game content generator. Given an educational standard and course, you will generate 5 key-value pairs to form content matches that adhere to the following rules.
Output Template
Each match should conform to the following template:
Match Key: a famous named event, action, policy, or socio-political movement that had a significant and unique effect on the course of history.
Match Value: a specific and unique change that happened as a direct, exclusive result of the Match Key.

### Task

1. Generate 5 key-value matches that tie the most famous events or actions directly related to the input Standard to specific historical consequences.
2. Use the Domain and Cluster inputs as additional context when selecting Match Key causes and their associated Match Value effects.
3. Ensure that each Match Key and its corresponding Match Value share a one-to-one relationship where the Match Key is the only plausible cause of that specific effect among the generated Match Keys.
4. Write a Learning Content for each Match Key, Match Value cause-effect pair that helps a student learn everything they need to know to match the Match Key cause to its Match Value effect.
5. Generate a Matching Game Title that summarizes the common, overarching topic referenced by the Match Keys and Match Values.
6. Rate the outputs on a scale of 1-10 for the following criteria:
*standard_relevance: How relevant is the matching exercise to the standard? Rate on a scale of 1-10. Integer only.
*learning_content_quality: How well does the learning content explain why the generated matches are correct? Rate on a scale of 1-10. Integer only.
*question_difficulty: How difficult is the matching exercise? Rate on a scale of 1-10. Integer only.
7. Respond with the list of Match Keys and Match Values and the Matching Game Title as outlined in the Output Format.

### Rules

### Match Key Generation:

Uniqueness: Each selected Match Key cause MUST be semantically unique.
Diversity: Each selected Match Key cause MUST be as different as possible from all other generated Match Key causes.
Fame: Generate Match Key causes that have famous, established names. Do NOT generate Match Keys which are descriptions of generic phenomena or concepts. Match Keys should be among the most famous historical events that can be tied to the Educational Standard
Match Key Syntax: All Match Key causes should be written in the same syntactic style. This includes verb tense, overall structure, and inclusion-exclusion of specific information. For example, if you give a year for one Match Key, you should give a year for all five. Or, if you use the noun form of a verb in one Match Key (e.g., “growth”), you shouldn't use a present tense verb in another key (e.g., use “immigration” rather than “immigrates”).
Event-based: The majority of the Match Keys in the set of 5 should be related to distinct events, rather than administrative policies or legislative or executive acts. Generate no more than 2 policy Match Keys. NEVER make Match Keys vague concepts.
Use Cluster Information: If you cannot generate 5 famous, established Match Keys associated with the input Standard, you are allowed to generate Match Keys using the information described by the input Cluster.
Good Match Key Examples: Here's a list of example Match Key causes whose selection, scope, and type you should seek to emulate in your generations: <“The Black Death,” “The Enlightenment,” “Martin Luther's 95 Theses,” “Treaty of Versailles”>.

### Match Value Generation:

Uniqueness: Each selected Match Value effect MUST be semantically unique.
Diversity: Each selected Match Value effect MUST be distinct enough to differentiate it from all other generated Match Value effects.
Sole Attribution: Each Match Value effect should be directly and solely attributed to its respective Match Key cause.
Single Phrase: Each generated Match Value effect must be described by a SINGLE, coherent phrase.

### Match Key and Match Value Presentation:

Consistent Structure: All generated Match Keys and Match Values should be presented using the SAME syntax, style, and narrative theme to ensure students cannot associate a Match Key Cause to its Match Value Effect on the basis of any non-content factors.
Proper Capitalization: Always capitalize the first word in each Match Key Cause. Always capitalize the first word in each Match Value Effect.

### Learning Content Rules:

Learning Content Definition: The Learning Content should be a brief, 2-sentence blurb. The first sentence should provide a succinct explanation of WHY the Match Key cause induced its Match Value effect, explaining the key logic supporting the causal nature of the Match Key and Match Value's relationship. The second sentence should provide an in-depth discussion of HOW the Match Key cause brought about its Match Value effect, focusing on the actual mechanics and progression of the causal relationship.
Standalone: Each Learning Content should be able to be understood without reading any of the other generated Learning Contents. Each Learning Content should not make references to or acknowledge the existence of any other Learning Contents.
Forbidden Words: Do NOT use the names of ANY of the Core Input fields or their values in generated Learning Content.
No Parentheses: All Learning Content should NOT use parentheses. Any additional or relevant information typically inserted within parentheses should be coherently embedded into the sentence.
No Abbreviations: All Learning Content should NOT use abbreviations. Common event abbreviations must be specified in their full, non-abbreviated form.
Learning Content Example: Here's an example of a Learning Content output that obeys all previous rules and whose style and structure you should seek to emulate: <The assassination of Archduke Franz Ferdinand led to the start of World War 1 by creating an unstable political climate where belligerent European leaders could justify escalating military actions and ultimately war. Specifically, the Archduke's death triggered the July Crisis which culminated in Austria-Hungary declaring war on Serbia and each nation's respective allies entering the fray, starting World War 1.>

### Matching Game Title Rules:

```
  - Length: The Matching Game Title MUST be 5 words or less. If it is longer than
5 words, re-generate it until it is 5 words or less.
  - Style: The Matching Game Title should sound like it is the name of a {{ course
}} textbook unit.
  Word Counts Restrictions:
  - Matching Game Title MUST be 5 words or less.
  - All Match Keys should be 4 words or less.
  - All Match Values should be 8 words or less, 1 sentence.
  - All Match Learning Content should be 30-40 words, 2 sentences.
  Output Format
  --------
  Format your response in valid JSON format with the following fields:
  {
    “matches”: [
      {
        “cause”: “”,
        “effect”: “”,
        “learning_content”: “”,
      }
    ],
    “matching_game_title”: “”,
    “ratings”: {
      “standard_relevance”: int,
      “learning_content_quality”: int,
      “difficulty”: int,
    }
  }
  Core Inputs
  --------
  Course: {{ course }}
  Domain: {{ standardDomain }}
  Cluster: {{ standardCluster }}
  Standard: {{ standardDescription }}
  Double Check Your Work:
  --------
```

Only complete this step after you have read and acted upon all other tasks and rules. Assume that your generated causes and effects are not famous and specific enough. Go back and generate them again, ensuring that your output meets the following criteria:
1. All causes must be highly specific and well-known and/or recognizable to a {{course}} teacher.
2. All effects must be highly specific and exclusively attributable to their respective causes.
3. Each Match Key, Match Value pair should represent one of the five most famous historical happenings that embody the educational essence of the Standard.
4. All Match Keys causes should share a common grammatical structure and syntax. All Match Value effects should share a common grammatical structure and syntax.

### Prompt Explanation:

The above prompt is for generating educational matching game content 102. Given an educational standard 116 and course details 118 as an input to generate 5 key-value pairs 108. Herein, the prompt is for AP US history. Similarly the prompt can be generated for various subjects such as AP World history, K12 social studies, AP biology, middle school and high school science. For each prompt for various subject context, output template, task, rules output format, core inputs are included in the prompt. Similarly, for different matching types the prompt is provided to the AI engine to generate key-pair values 108.

### Below is the Exemplary Output:

```
{
  “matches”: [
    {
      “cause”: “The spread of Islam in South Asia”,
      “effect”: “The establishment of the Delhi Sultanate”,
      “learning_content”: “The spread of Islam in South Asia led to the establishment of the
Delhi Sultanate, as Muslim invaders set up the Sultanate to govern their newly acquired
territories.”
    },
    {
      “cause”: “The spread of Buddhism in Southeast Asia”,
      “effect”: “The construction of important Buddhist monuments”,
      “learning_content”: “The spread of Buddhism in Southeast Asia resulted in the
construction of important Buddhist monuments, such as Borobudur in Indonesia and Angkor
Wat in Cambodia, to serve as religious and cultural centers.”
    },
    {
      “cause”: “The growth of trade networks in South and Southeast Asia”,
      “effect”: “The emergence of powerful trading cities”,
      “learning_content”: “The growth of trade networks in South and Southeast Asia led to
the emergence of powerful trading cities, such as Melaka in Malaysia and Calicut in India,
which became major centers of commerce and cultural exchange.”
    },
    {
      “cause”: “The revival of Hinduism in South Asia”,
      “effect”: “The construction of Hindu temples”,
      “learning_content”: “The revival of Hinduism in South Asia resulted in the
construction of Hindu temples, such as the Brihadeeswarar Temple in India, which served as
important religious and architectural landmarks.”
    },
    {
      “cause”: “The spread of Indian Ocean maritime trade”,
      “effect”: “The cultural diffusion of Indian knowledge and technologies”,
      “learning_content”: “The spread of Indian Ocean maritime trade facilitated the
cultural diffusion of Indian knowledge and technologies, including mathematics, astronomy,
and shipbuilding, to various regions in South and Southeast Asia.”
    }
  ],
  “matching_game_title”: “Religious and Trade Influences in South and Southeast Asia”,
  “ratings”: {
    “standard_relevance”: 8,
    “learning_content_quality”: 9,
    “difficulty”: 6
  }
}
```

### Output Explanation:

The above output is generated for cause and effect type. Typically, five key-value pairs 108 are generated. Moreover, the generated output includes standard relevance, learning content quality, and difficulty level.

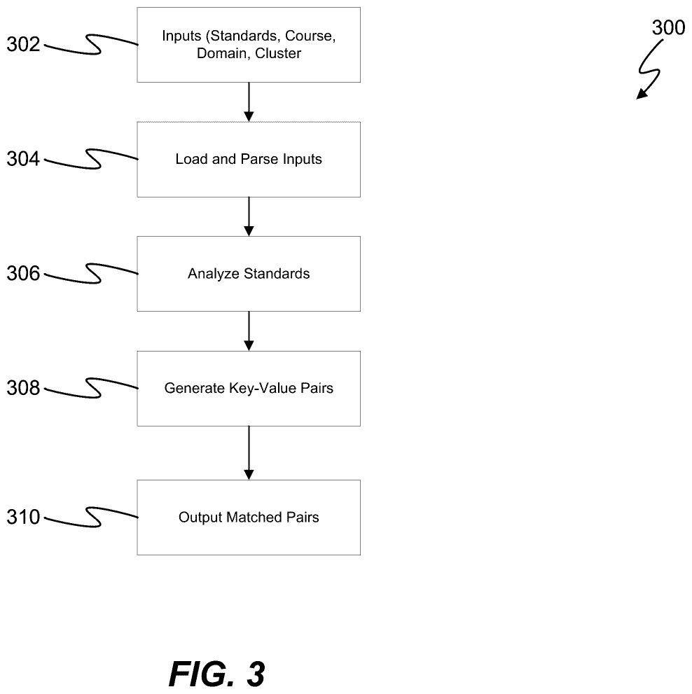

FIG. 3 depicts an educational matching game content generation process 300, which is an embodiment of the content generation process 200 of FIG. 2. At step 302, receiving input including standards, courses domains and clusters. At step 304, loading and parsing the received input data. At step 306, based on the received input the education standard 116 is analyzed. At step 308, based on the analyzed educational standard 116 the key-value pain 108 is generated. At step 310, based on the generated key-value pain 108 the output educational matching game content 104 is generated.

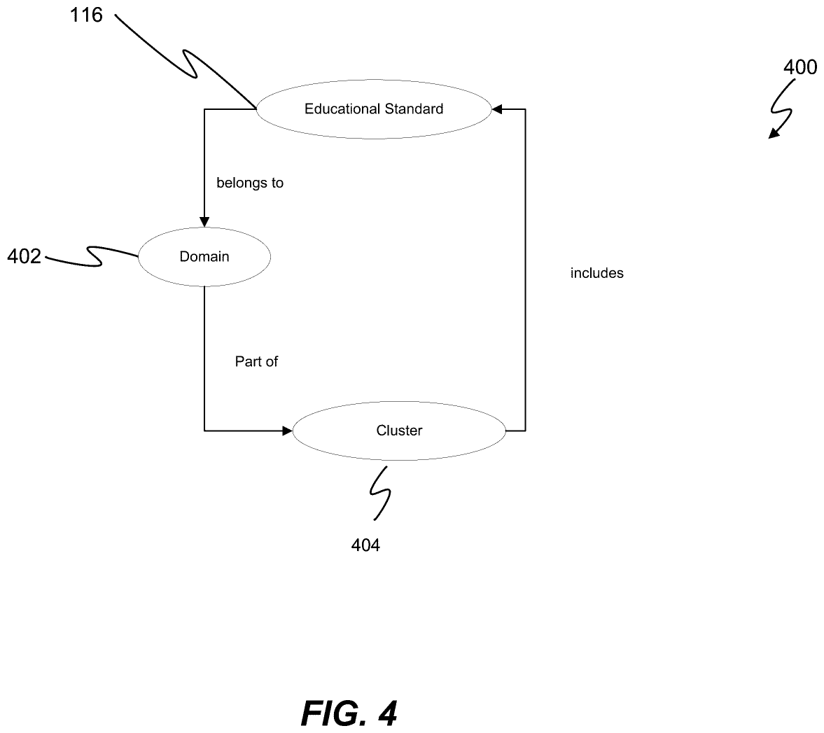

FIG. 4 depicts a relationship 400 between educational standard 116, domain 402, and cluster 404. As shown, the domain 402 belongs to the educational standard 116. The cluster 404 is a part of the domain 402. The educational standard 116 includes the cluster 404.

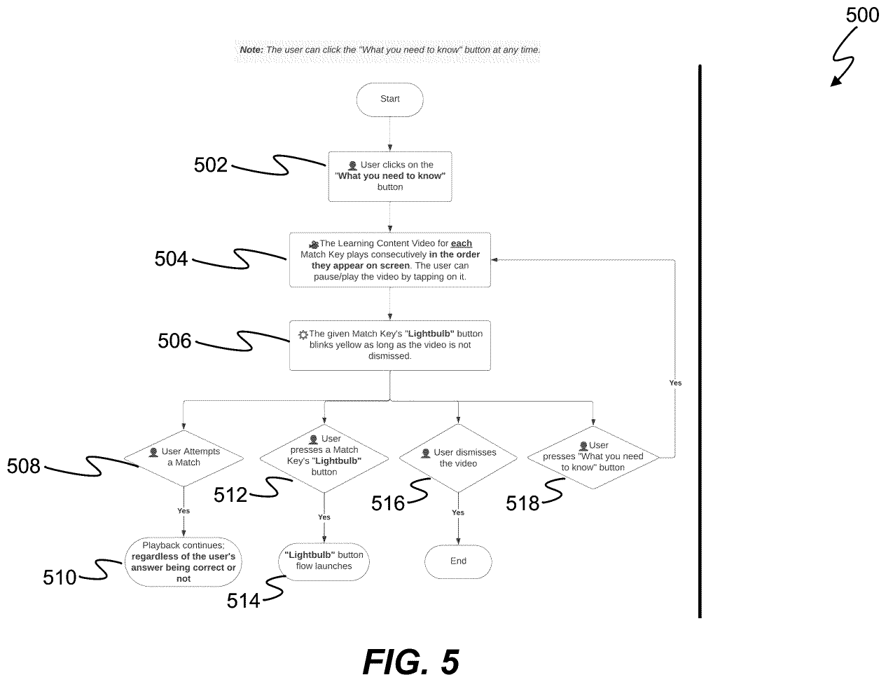

FIG. 5 depicts an exemplary user interaction process 500, which is an embodiment of the content generation process 200 of FIG. 2. As shown, at step 502, the user clicks on the “what you need to know” button on the user interface. At step 504, the learning content video response 114 for each match key plays consecutively in the order they appear on screen of the user interface. The user can pause/play the video response 114 by tapping on it. At step 506, a lightbulb button blinks yellow as long as the video response 114 is not dismissed. At step 508, if the user attempts a match. At step 510, the video response 114 continues to play regardless of the user response being correct or not. At step 512, if the user presses a match key lightbulb button. At step 514, lightbulb bulb flow launched. At step 516. At step 516, if the user dismissed the video response 114 the playback of the video response 114 stopped. At step 518, the user presses what you need to know button to continue from step 504.

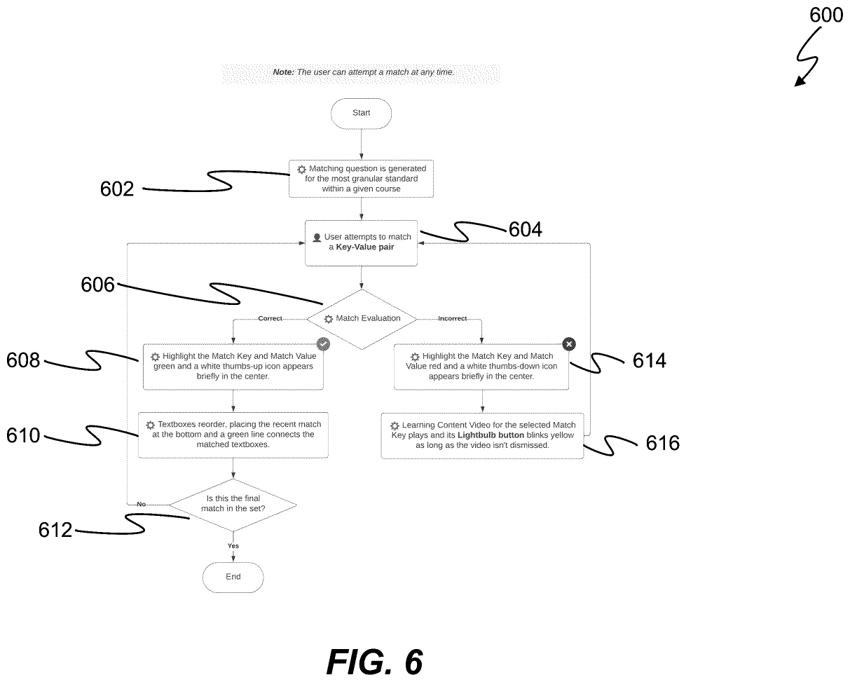

FIG. 6 depicts another exemplary user interaction process 600, which is an embodiment of the content generation process 200 of FIG. 2. As shown, at step 602, educational matching game content 104 is generated for the educational standard 116 within a given course detail 118. At step 604, the user attempts to match the key-value pair 108. At step 606, the content generation system 100 evaluated the matching. If the matching is correct, at step 608, highlight the match key and match value green and a white thumbs-up icon appears briefly in the center of the user interface. At step 610, the textboxes reorder, placing the recent match at the bottom and the green line connects the matched textboxes. At step 612, the content generation system 100 identifies the final match in the set. If yes the process will end, if no then step 604 continues. If the matching is incorrect, at step 614, highlight the match key and match value red and a white thumbs-down icon appears briefly in the center of the user interface. At step 616, learning content video response 114 for the selected match key plays and the lightbulb button blinks yellow as long as the video response 114 is not dismissed.

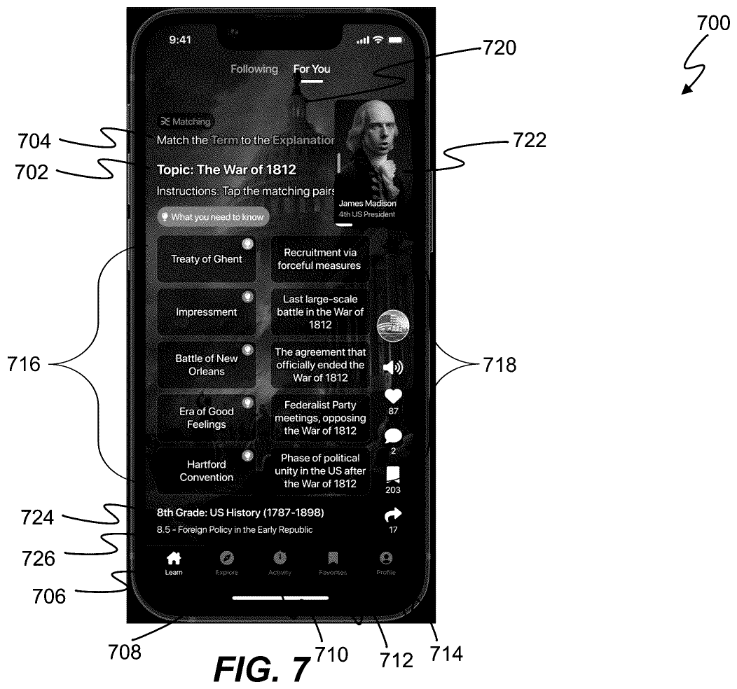

FIGS. 7-10 are exemplary user interfaces 700, 800, 900, 1000 depicting interaction between the user and the online learning platform. Referring to FIG. 7, as shown the user interface 700 themed on The War of 1812. The screen features interactive elements such as topic headers 702, matching type 704 for historical terms and explanations, and navigational tabs such as learn 706, explore 708, activity 710, favorites 712 and profiles 714. The user interface 700 shows an interactive quiz related to The War of 1812. The user interface 700 displays various historical terms 716 associated with the topic headers 702 and asks the users to match the terms 716 with their descriptions 718. The user interface 700 also displays the visual elements such as background image 720 of the U.S. Capitol and a historical FIG. 722 James Madison. Moreover, the user interface 700 is focused on grade 724 8th Grade U.S. History, specifically highlighting the segment 726 on Foreign Policy in the Early Republic.

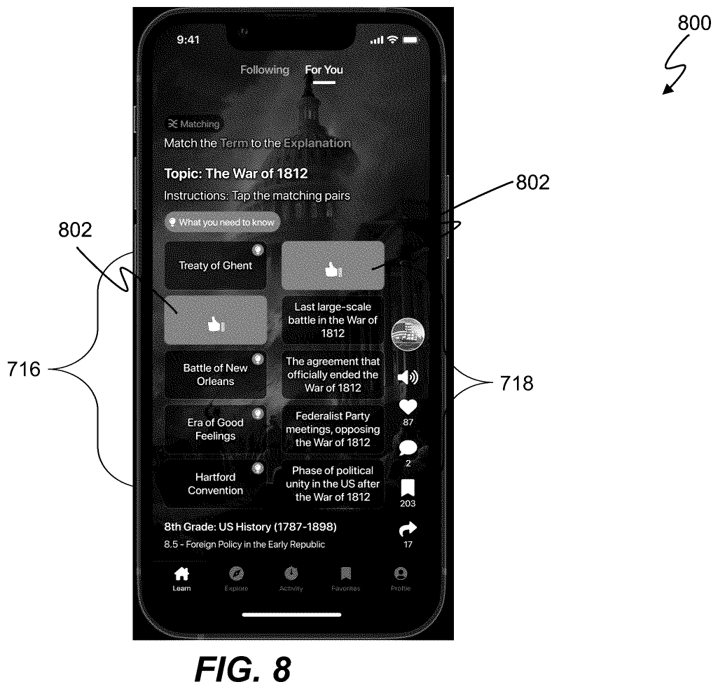

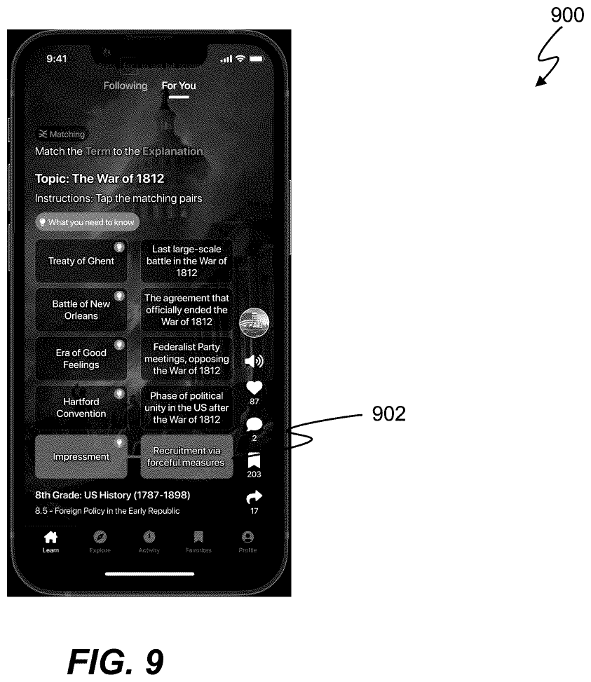

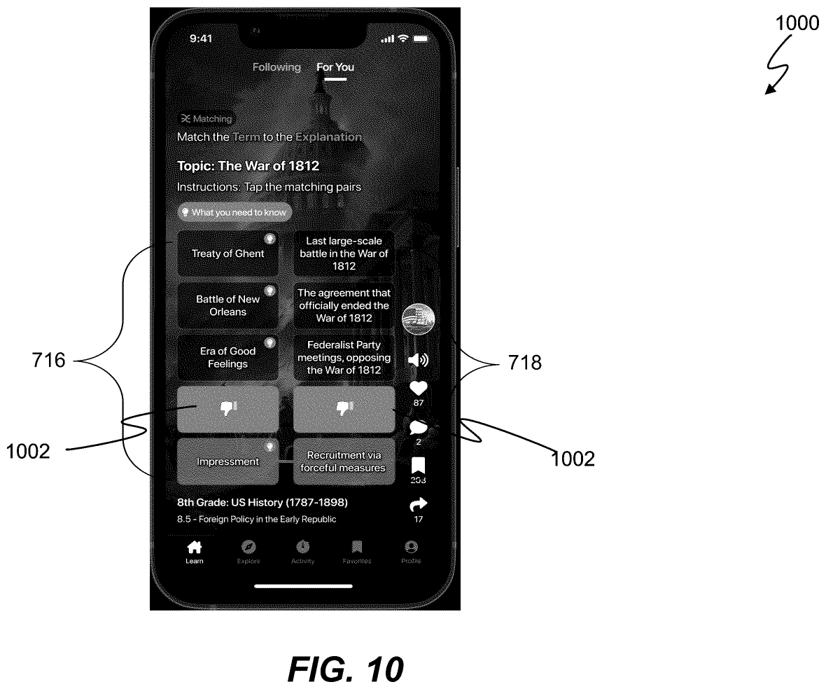

Referring to FIG. 8, as shown the user interface 800 features the educational matching game content 104 related to the War of 1812, providing various historical terms 716 and descriptions 718 for users to match. As shown on a correct match of the key value pair 108, a thumbs-up 802 appears on the user interface 800. Referring to FIG. 9, as shown the user interface 900 focusing on the War of 1812. It features an interactive matching activity 902 where users connect terms to their explanations. The correct answer for the matching type 704 is moved on the bottom. Referring to FIG. 10, as shown the user interface 1000 on an incorrect match of the key value pair 108, a thumbs-down 1002 appears on the user interface 1000.

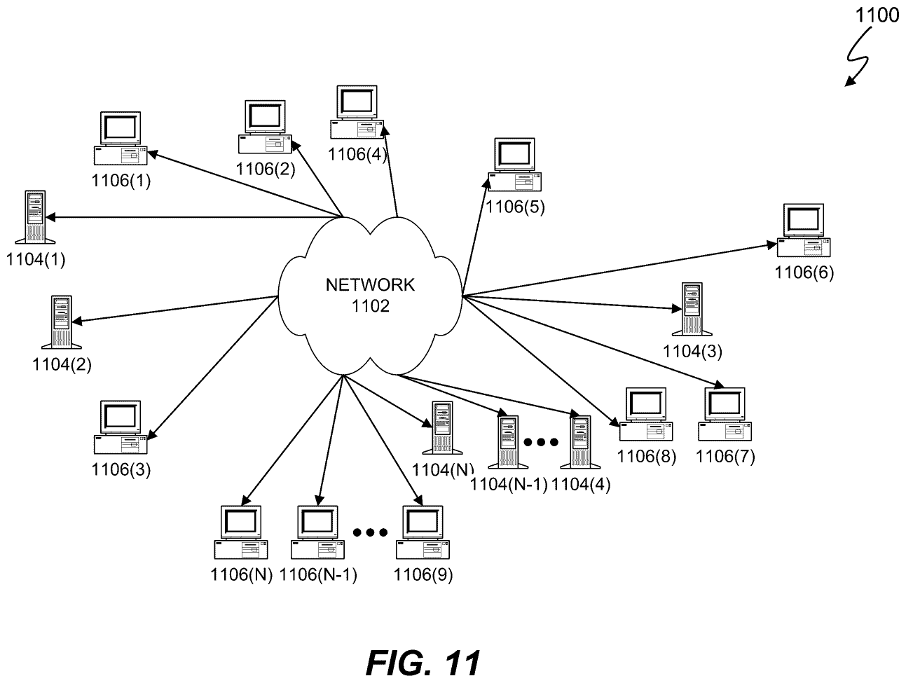

FIG. 11 is a block diagram illustrating a network environment in which a content generation system 100 and content generation process 200 may be practiced. Network 1102 (e.g. a private wide area network (WAN) or the Internet) includes a number of networked server computer systems 1104(1)-(N) that are accessible by client computer systems 1106(1)-(N), where N is the number of server computer systems connected to the network. Communication between client computer systems 1106(1)-(N) and server computer systems 1104(1)-(N) typically occurs over a network, such as a public switched telephone network over asynchronous digital subscriber line (ADSL) telephone lines or high-bandwidth trunks, for example communications channels providing T1 or OC3 service. Client computer systems 1106(1)-(N) typically access server computer systems 1104(1)-(N) through a service provider, such as an internet service provider (“ISP”) by executing application specific software, commonly referred to as a browser, on one of client computer systems 1106(1)-(N).

Client computer systems 1106(1)-(N) and/or server computer systems 1104(1)-(N) are specialized computer programmed to improve conventional computer systems to implement and utilize the content generation system 100 and content generation process 200. The type of computer system that can be specially programmed to implement and utilize the content generation system 100 and content generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the content generation system 100 and content generation process 200 can be implemented using code stored in a tangible, non-transient computer readable medium and executed by one or more processors. In at least one embodiment, the content generation system 100 and content generation process 200 can be implemented completely in hardware using, for example, logic circuits and other circuits including field programmable gate arrays.

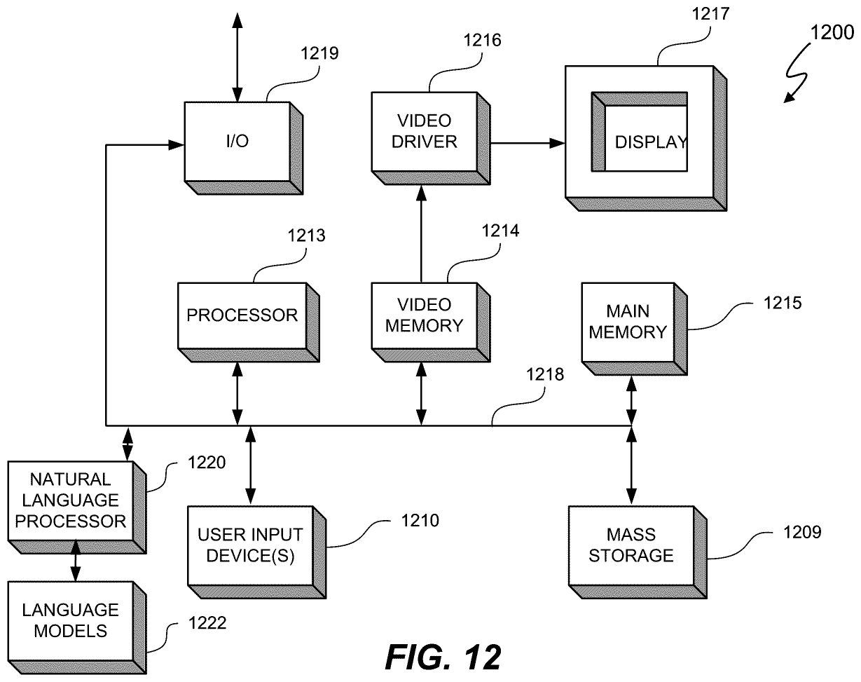

Embodiments of the content generation system 100 and content generation process 200 can be implemented on a computer system such as a special-purpose, special-programmed computer 1200 illustrated in FIG. 12. Input user device(s) 1210, such as a keyboard and/or mouse, are coupled to a bi-directional system bus 1218. The input user device(s) 1210 are for introducing user input to the computer system and communicating that user input to processor 1213. The computer system of FIG. 12 generally also includes a non-transitory video memory 1214, non-transitory main memory 1215, and non-transitory mass storage 1209, all coupled to bi-directional system bus 1218 along with input user device(s) 1210 and processor 1213. The mass storage 1209 may include both fixed and removable media, such as a hard drive, one or more CDs or DVDs, solid state memory including flash memory, and other available mass storage technology. Bus 1218 may contain, for example, 32 of 64 address lines for addressing video memory 1214 or main memory 1215. The system bus 1218 also includes, for example, an n-bit data bus for transferring DATA between and among the components, such as CPU 1209, main memory 1215, video memory 1214 and mass storage 1209, where “n” is, for example, 32 or 64. Alternatively, multiplex data/address lines may be used instead of separate data and address lines.

I/O device(s) 1219 may provide connections to peripheral devices, such as a printer, and may also provide a direct connection to a remote server computer systems via a telephone link or to the Internet via an ISP. I/O device(s) 1219 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1209, into main memory 1215 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1213, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1215 is comprised of dynamic random access memory (DRAM). Video memory 1214 is a dual-ported video random access memory. One port of the video memory 1214 is coupled to video amplifier 1216. The video amplifier 1216 is used to drive the display 1217. Video amplifier 1216 is well known in the art and may be implemented by any suitable means. This circuitry converts pixel DATA stored in video memory 1214 to a raster signal suitable for use by display 1217. Display 1217 is a type of monitor suitable for displaying graphic images.

The computer system described above is for purposes of example only. The content generation system 100 and content generation process 200 may be implemented in any type of computer system or programming or processing environment. It is contemplated that the content generation system 100 and content generation process 200 might be run on a stand-alone computer system, such as the one described above. The content generation system 100 and content generation process 200 might also be run from a server computer systems system that can be accessed by a plurality of client computer systems interconnected over an intranet network. Finally, the content generation system 100 and content generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method that integrates programmatic control and a guided and constrained Artificial Intelligence (AI) engine to utilize educational content for dynamically generating an educational matching game content comprising:
executing code using one or more processors of a computer system to cause the computer system to perform operations comprising:
utilizing an educational curriculum database for receiving input, wherein the input includes educational standards and course details;
retrieving information for a historical figure relevant to the educational standard from the educational curriculum database, wherein the relevant information for the historical figure includes historical figure image, voice;
utilizing the AI engine to generate facts for the educational standard associated with the educational matching game content;
generating a video response using a video generation module to present the educational content using the historical figure;
generating a prompt to guide the AI engine to analyze educational content and generate key-value pairs;
transferring the prompt to the AI engine to generate key-value pairs, wherein the key represents a significant educational concept or event, and the value provides a detailed explanation or outcome related to the key; and
displaying the generated educational matching game content and the generated video response.

2. The method of claim 1 wherein automatically updating and generating educational content based on the receive updates related to changes in the educational standard.

3. The method of claim 1 wherein the educational matching game content is generated from cause to effect type, term to explanation type, people to event type, event to date type.

4. The method of claim 1 wherein the key-value pairs are generated using a rules-based engine, the rule based engine is configured to ensure alignment of the key-value pairs with specific educational standards to generate contextually relevant educational matching game content.

5. The method of claim 1 wherein the AI engine is configured to customize the difficulty level of the generated educational matching game content based on the educational level of a user.

6. The method of claim 1 further comprising:
receiving the input representing educational standards and course details;
categorizing the received data into a structured format.

7. The method of claim 1 further comprising:
a plurality of data structures configured to optimize the management, storage, and retrieval of educational content by aligning the educational content with specific educational standards to enhance the dynamic generation of the educational content for generating the educational matching game content.

8. A system that integrates programmatic control and a guided and constrained Artificial Intelligence (AI) engine to to utilize educational content for dynamically generating an educational matching game content comprising:
one or more processors of a computer system; and
a memory, coupled to the one or more processors, storing code that when executed causes the computer system to perform operations comprising:
utilizing an educational curriculum database for receiving input, wherein the input includes educational standards and course details;
retrieving information for a historical figure relevant to the educational standard from the educational curriculum database, wherein the relevant information for the historical figure includes historical figure image, voice;
utilizing the AI engine to generate facts for the educational standard associated with the educational matching game content;
generating a video response using a video generation module to present the educational content using the historical figure;
generating a prompt to guide the AI engine to analyze educational content and generate key-value pairs;
transferring the prompt to the AI engine to generate key-value pairs, wherein the key represents a significant educational concept or event, and the value provides a detailed explanation or outcome related to the key; and
displaying the generated educational matching game content and the generated video response.

9. The system of claim 8 wherein automatically updating and generating educational content based on the receive updates related to changes in the educational standard.

10. The system of claim 8 wherein the educational matching game content is generated from cause to effect type, term to explanation type, people to event type, event to date type.

11. The system of claim 8 wherein the key-value pairs are generated using a rules-based engine, the rule based engine is configured to ensure alignment of the key-value pairs with specific educational standards to generate contextually relevant educational matching game content.

12. The system of claim 8 wherein the AI engine is configured to customize the difficulty level of the generated educational matching game content based on the educational level of a user.

13. The system of claim 8 further comprising:
receiving the input representing educational standards and course details;
categorizing the received data into a structured format.

14. The system of claim 8 further comprising:
a plurality of data structures configured to optimize the management, storage, and retrieval of educational content by aligning the educational content with specific educational standards to enhance the dynamic generation of the educational content for generating the educational matching game content.
